(19) United States
(12) Patent Application Publication
(10) Pub. No.: US 2021/0316647 A1
(43) Pub. Date: Oct. 14, 2021

(54) CUP HOLDER TABLE

(71) Applicant: K&C Innovations, LLC, Muskegon, MI (US)

(72) Inventors: James Kosheba, Muskegon, MI (US); John Conran, Ravenna, MI (US)

(73) Assignee: K&C Innovations, LLC, Muskegon, MI (US)

(21) Appl. No.: 17/229,541

(22) Filed: Apr. 13, 2021

Related U.S. Application Data
(60) Provisional application No. 63/009,826, filed on Apr. 14, 2020.

(51) Int. Cl. B60N 3/10; B60N 3/00

(52) U.S. Cl. CPC B60N 3/101; B60N 3/002

(57) ABSTRACT

A tray and tray platform insert for mounting in a vehicle cup holder, in which said tray includes a platform with a downwardly projecting platform opening eccentrically located in said tray platform for fitting into a vehicle cup holder. The platform insert has an eccentrically located opening and is configured to be repositionable on the tray platform such that either:
(1) the platform insert opening is positioned in alignment with said tray platform opening, allowing a cup to be supported through said aligned openings, or
(2) said platform insert opening is not aligned with said tray platform opening, such that the tray and insert present a continuous supporting surface for placing items in the tray.

Alternatively, the platform insert is configured to have a solid surface with no openings, and with a cup holder projecting upwardly from one surface for holding a cup. The cup holder is configured such that when the platform insert is inverted, the cup holder projects downwardly through said eccentrically located opening in said tray platform.

### CLAIM OF PRIORITY

This patent application claims priority to provisional application Ser. No. 63/009,826 filed Apr. 14, 2020, entitled CUP HOLDER TABLE.

### DISCUSSION OF THE FIELD AND BACKGROUND

The present invention relates to the field of vehicle cup holders and accessories therefor.

The prior art discloses cup holder-table or tray combinations for use in connection with vehicle cup holders:
Thomas U.S. Pat. No. 6,533,233, Hudson U.S. Pat. No. 6,732,990, Magee U.S. Pat. No. 7,681,852, Mak et al. U.S. Pat. No. 9,845,038 and Mango U.S. Pat. No. 9,199,584.

### SUMMARY OF THE INVENTION

The present invention is a tray which can be mounted in a vehicle cup holder. The tray has a platform surface which is larger than the opening in a vehicle cup holder. The tray platform surface includes an opening into a downwardly depending mount configured for insertion into the vehicle cup holder. The tray also includes a platform insert configured to be oriented either (1) in a position in which the tray and insert present a continuous supporting surface for placing items in the tray, or (2) in a position in which the tray and insert provides a cup holder.

In one embodiment, said tray platform opening is eccentrically located in said tray platform surface and said platform insert has an eccentrically located opening. The platform insert is configured to be repositionable on said tray platform surface such that either:
(1) said platform insert opening is positioned in alignment with said opening in said tray platform surface, allowing a cup to be supported through said aligned openings, or
(2) said platform insert opening is not aligned with said tray platform opening, the tray and insert present a continuous supporting surface for placing items in the tray.

In another embodiment, the platform insert is configured to have a solid surface with no openings, and with a cup holder projecting upwardly from one surface for holding a cup. The cup holder is configured such that when the platform insert is inverted, the cup holder projects downwardly through said eccentrically located opening in said tray platform.

These and other objects, features and advantages will be more fully understood and appreciated by reference to the written specification and appended drawings.

### BRIEF DESCRIPTION OF THE DRAWINGS

FIG. 1 is a perspective view of the tray 1 and its separate platform insert 30;

FIG. 2 is a perspective view of tray 1;

FIG. 3 is a perspective view of tray 1 with platform insert 30 in place, with tray and insert openings aligned and a cup being supported through the aligned openings;

FIG. 4 is a perspective view of tray 1 with platform insert 30 in place, tray and insert openings non-aligned, such tray 1 and insert 30 provide a continuous support surface for items placed in the tray;

FIG. 5 is a perspective view of tray 1 and its separate alternative embodiment platform insert 40;

FIG. 6 is a perspective view of tray 1 with platform insert 40 in place, facing upward so that cup holder projection 41 is exposed, and a cup is supported in it;

FIG. 7 is a perspective view of tray 1 with platform insert 40 in place, facing upward with a cell phone mounted in the slots 42 in holder projection 41;

FIG. 8 is a perspective view of tray 1 with platform insert 40 in place but inverted so that cup holder projection 41 extends downwardly into the opening in tray 1, and tray 1 and insert 40 provide a continuous support surface for items placed in the tray;

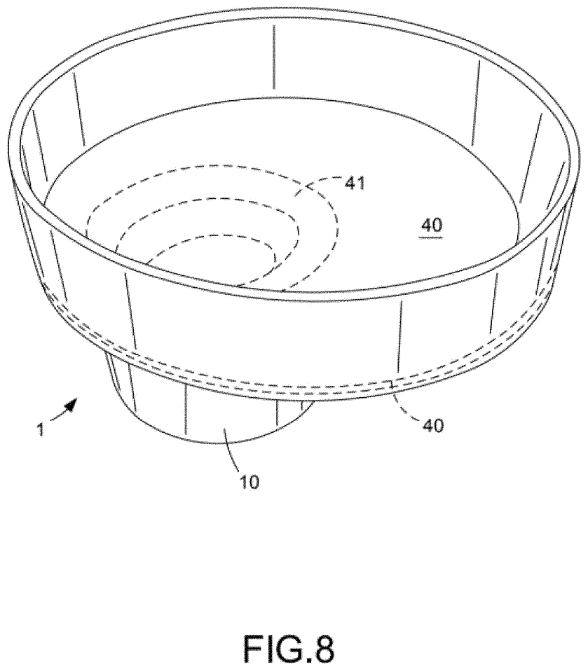

FIG. 9 is a cross sectional view of tray 1 positioned above the receiving cup holder 52 of a suction cup mounted cup holder 50; and

FIG. 10 is a perspective view of tray 1 positioned above the receiving holder 62 of a sidewall mounted suction cup holder 60.

### DESCRIPTION OF THE PREFERRED EMBODIMENTS

In the preferred embodiments, tray 1 is adapted for use in any vehicle cup holders. Vehicle cup holders typically include a downwardly opening well in a surrounding surface, in which the well is configured to receive and hold a cup or glass. The term “vehicle cup holder” is intended to cover any such cup holder no matter what type of vehicle, boat, or airplane it is in.

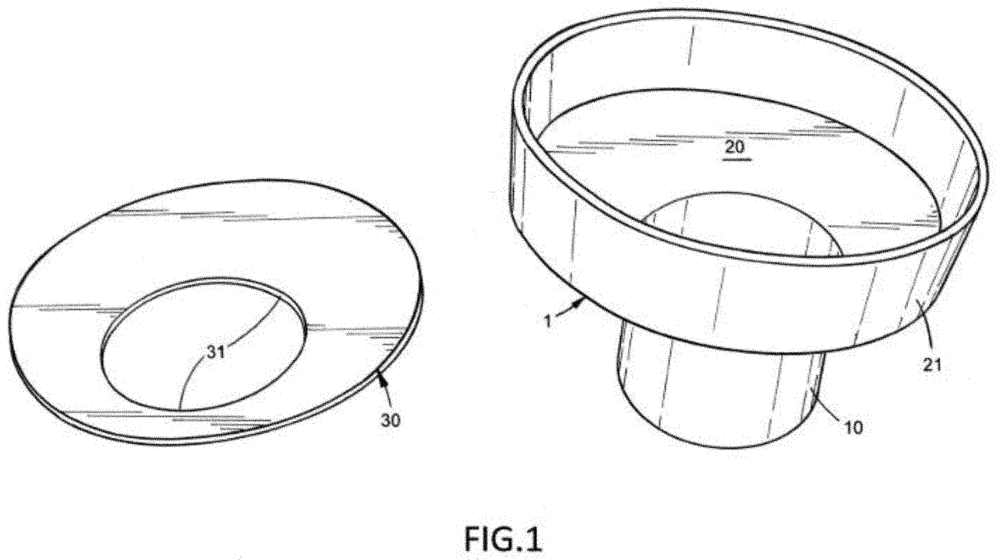

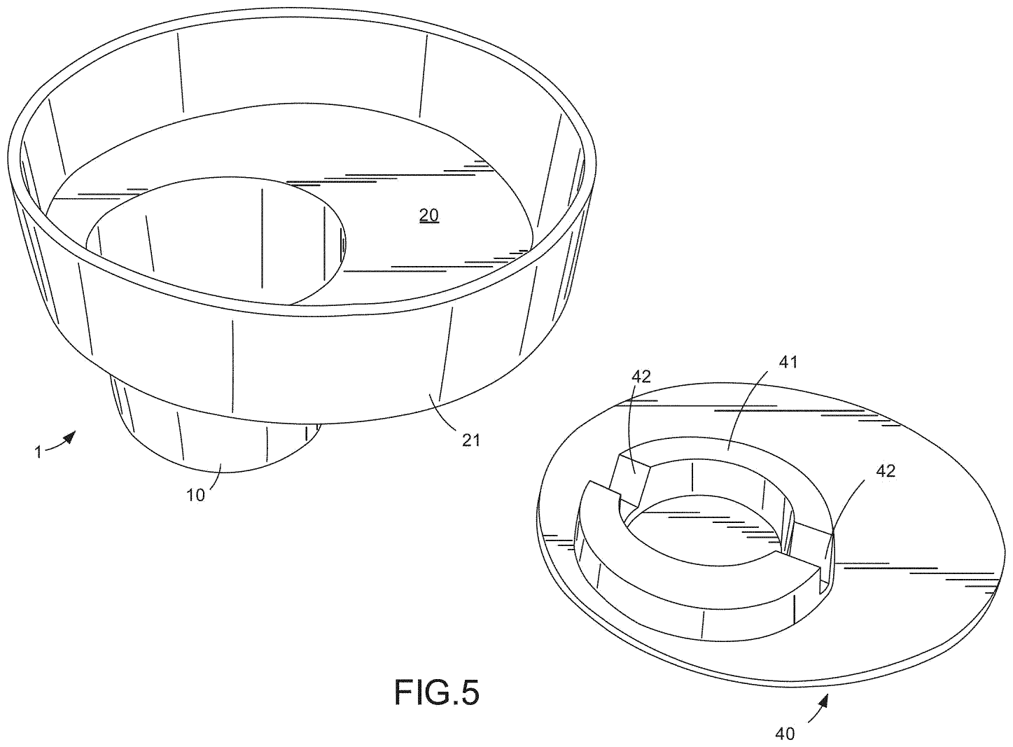

Tray 1 comprises a platform surface 20 which is larger than the opening in the well of a vehicle cup holder (FIGS. 1 and 5). Tray platform surface 20 includes an opening 10a into a downwardly depending mount 10 configured for insertion into the well of a vehicle cup holder. In the preferred embodiment, mount 10 comprises a cylindrical sleeve. A circumferential wall 21 extends upwardly from the perimeter of platform 20 in order to keep food or other items which are placed on platform 20 from falling off.

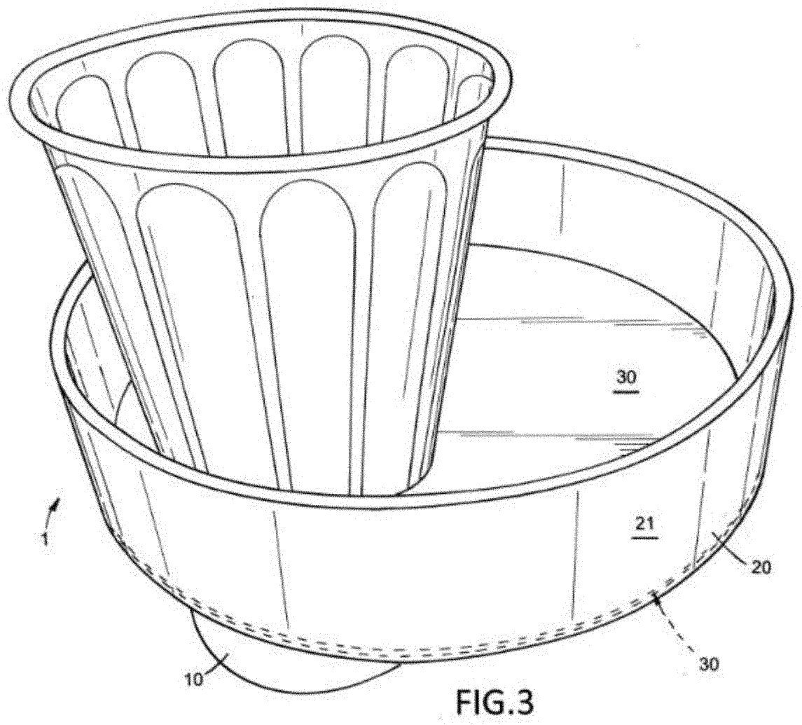

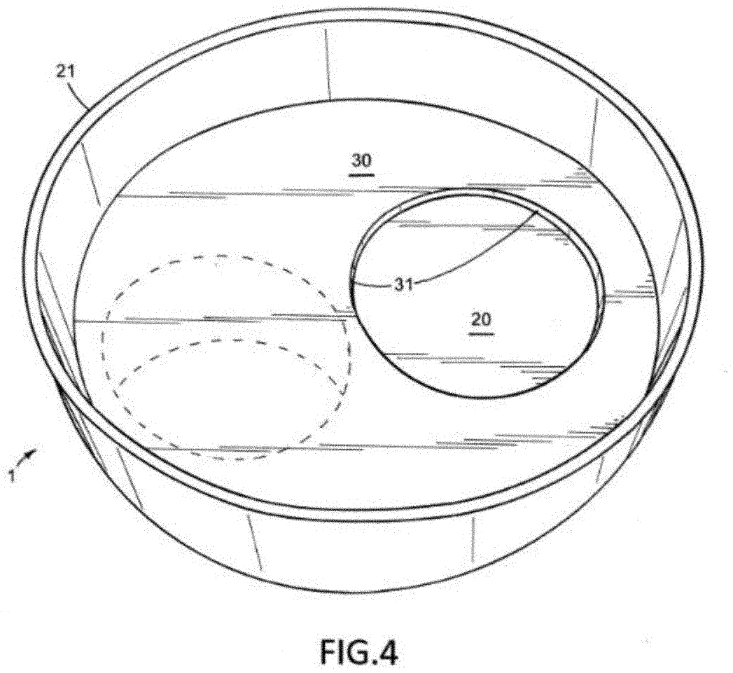

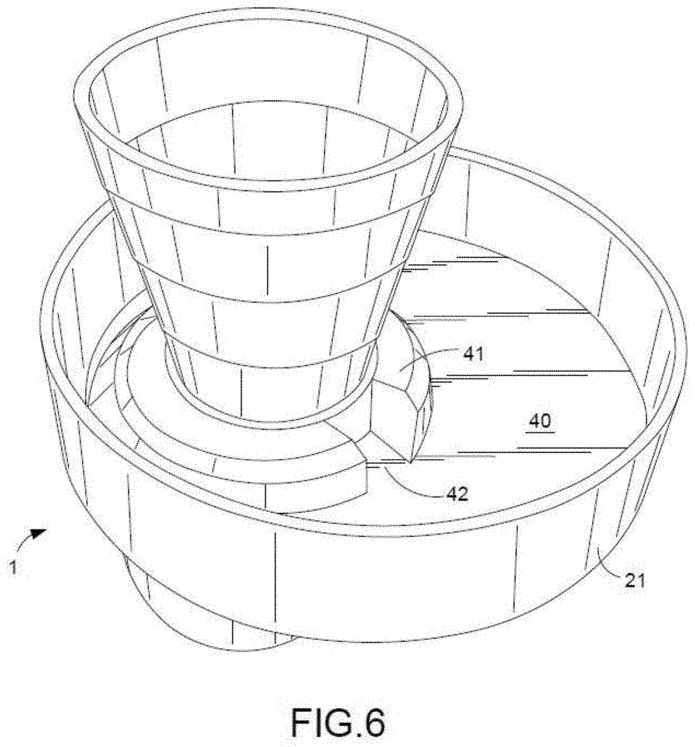

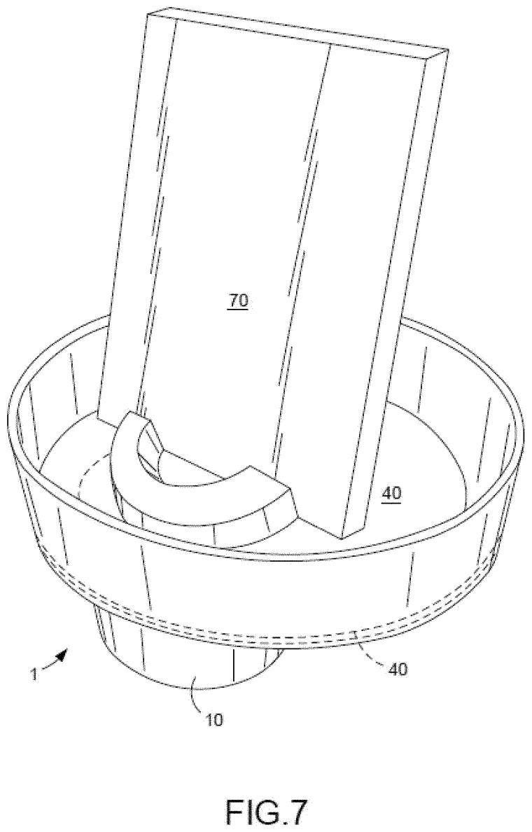

Tray 1 also includes alternative embodiment platform inserts 30 and/or 40, both of which have the same overall dimensions as platform 20 of tray 1. In addition, both insert 30 and 40 are configured to be oriented either (1) in a position in which the tray and insert, present a continuous supporting surface for placing items in the tray (FIGS. 4 and 7), or (2) in a position in which the tray and insert provides a cup holder (FIGS. 3 and 6).

Preferably, the opening 10a in the platform 20 of tray 1 is eccentrically located, so as to leave more of the supporting surface of platform 20 off to one side of and extending away from opening 10a. This provides a wider uninterrupted surface for placing food and other objects on.

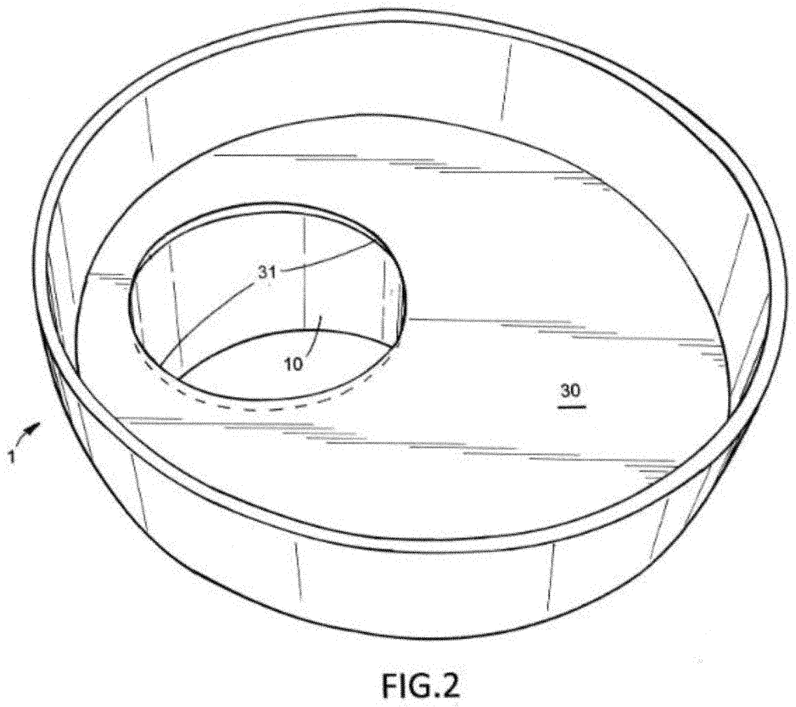

This eccentrically located arrangement for opening 10a is also necessary for use with platform insert 30. Platform insert 30 is also provided with an eccentrically located opening 31 whose location and size conform to the location and size of opening 10a in platform 20. Platform insert 30 can thus be located on top of platform 20 of tray 1, with opening 31 aligned with opening 10a (FIG. 2). A cup or glass can be placed in tray 1 so as to extend through aligned openings 31 and 10a, down into the well formed by cylindrical sleeve/mount 10 (FIG. 3).

However, the relative dimensions of platform 20 and platform insert 30 are such that platform insert 30 can be repositioned on platform 20 with its eccentrically located opening 31 out of alignment with the eccentrically located opening 10a of platform 20 (FIG. 4). In this way, platform insert 30 and tray platform 20 combine to form a continuous support surface for food and other objects placed in tray 1. Preferably, platform 20 and platform insert 30 are circular, such that repositioning insert 30 from an opening aligned position to an opening non-aligned position is easily accomplished by simply rotating insert 30 on platform 20. Of course, realignment could also be accomplished regardless of the shape of platform 20 and insert 30 simply by inverting insert 30 in a direction which locates the eccentric openings out of alignment with each other.

Alternative embodiment platform insert 40 has a solid support surface with no openings in it (FIG. 5). It does, however, have, a cup receiver 41 projecting upwardly from the surface of platform insert 40 for accommodating cups positioned therein (FIG. 6). Cup receiver 41 preferably comprises a ring-shaped perimeter wall extending upwardly from the surface of insert 40. The shape and dimension of cup receiver 41 correspond to the shape and dimensions of opening 10a in platform 20, such that when platform insert 40 is inverted, cup receiver 41 fits down through platform opening 10a and extends into sleeve/mount 10 (FIG. 7). In this inverted position, platform insert 40 provides a continuous support surface for food and other items placed in tray 1.

Preferably, cup receiver projection 41 is eccentrically located on insert 40, so as to leave more of the supporting surface of platform insert 40 off to one side of and extending away from opening 10a. This provides a wider uninterrupted surface for placing food and other objects on when insert 40 is in position with its cup receiver 41 projecting upwardly. This requires a corresponding eccentric location for opening 10a and sleeve 10 in platform 20, such that upon inversion, projecting cup receiver projects down through opening 10a and into sleeve/mount 10.

Preferably, cup receiver ring 41 includes opposing slots 42 in the ring for receiving a cell phone 70 instead of a cup (FIGS. 5 and 7). Preferably the slots 42 are inclined slightly away from the driver, at least on one side, such that the cell phone faces upwardly toward the driver.

By using the same eccentric location for cup receiver 41 as is used for eccentrically located opening 31 in platform insert 30, platform inserts 40 and 30 can each be used with the same tray 1. They can both be sold as a package with tray 1, or either can be sold with tray 1 as separate packages.

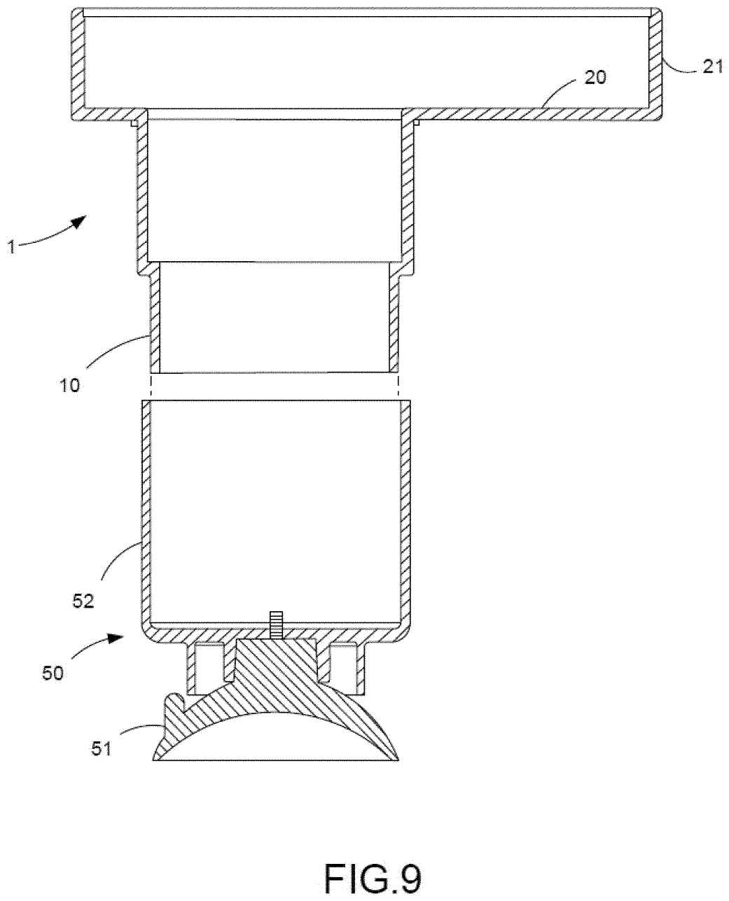

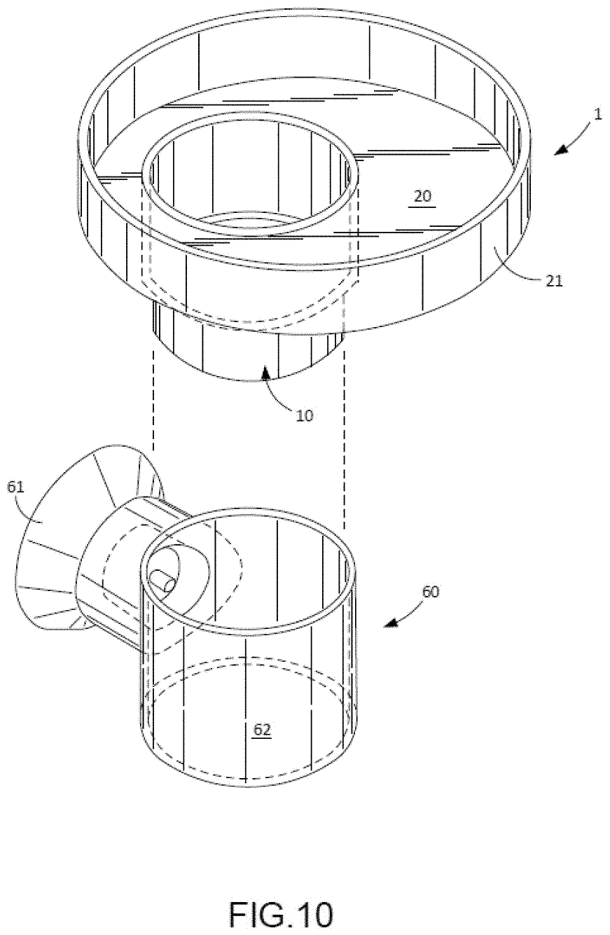

FIGS. 9 and 10 show embodiments in which tray 1 is used in suction cup mounted cup holders 50 and 60, respectively. Cup holder 50 can be conveniently mounted on a horizontal surface in a boat, for example, by means of a bottom suction cup mount 51 connected to an upstanding cup holder 52 (FIG. 9). Tray 1 fits down into cup holder portion 52 and can be used in all of the ways discussed above.

Cup holder 60 is a side wall mounted cup holder (FIG. 10). Suction cup 61 is connected to the side of cup holder portion 62, such that holder 62 faces upwardly. Tray 1 fits down into cup holder portion 62 and can be used in all of the ways discussed above.

Of course, the forgoing are preferred embodiments of the invention, and can by modified without departing from the spirit and concept of the invention.

1. A tray and a platform insert in said tray for mounting in a vehicle cup holder, said tray comprising: a platform which is larger than the opening in a vehicle cup holder; said platform including an opening into a downwardly depending open mount configured for insertion into the vehicle cup holder; said open mount comprising an open sleeve into which a cup can be inserted; said platform insert being configured for positioning on said platform surface; said platform insert having an opening therein, and being configured to be oriented either (1) in a position in which said platform insert opening is positioned away from said open sleeve, such that said tray and said platform insert present a continuous supporting surface for placing items in said tray, or (2) in a position in which said platform insert opening is aligned with said open sleeve such that said tray and said platform insert provide a cup holder.

2. The tray and platform insert of claim 1 in which said tray platform downwardly depending open mount is eccentrically located in said tray platform and said opening in said platform insert opening is eccentrically located in said platform insert; whereby in said position 1 said eccentric openings are not aligned, but in said position 2 said eccentric openings are aligned.

3. The tray and platform insert of claim 2 in which said platform and said platform insert are circular, such that repositioning said platform insert from an opening aligned position to an opening non-aligned position is easily accomplished by simply rotating said platform insert on said platform.

4. The tray and platform insert of claim 2 in which said platform insert is flat such that repositioning of said platform insert between said positions 1 and 2 can be accomplished regardless of the shape of platform and said platform insert simply by inverting said platform insert in a direction which locates said eccentric openings in said platform, and said platform insert out of alignment with each other or into alignment with each other.

5. A tray and a platform insert in said tray for mounting in a vehicle cup holder, said platform being than the opening in a vehicle cup holder; said platform including an opening into a downwardly depending open mount configured for insertion into the vehicle cup holder; said open mount comprising an open sleeve into which a cup can be inserted; said platform insert being configured to have a solid surface with no openings, and having a cup receiver projecting upwardly from one surface of said platform insert for holding a cup; said cup receiver on said platform insert being configured such that, when said platform insert is inverted, said platform insert cup receiver projects downwardly through said opening in said tray platform.

6. The tray and platform insert of claim 5 in which said tray platform downwardly depending open mount is eccentrically located in said tray platform and said cup receiver in said platform insert opening is eccentrically located in said platform insert; whereby when said platform insert is positioned with said cup receiver projecting upwardly, said cup receiver is eccentrically located on said platform insert so as to leave more of the supporting surface of said platform insert off to one side of said platform insert providing a wider uninterrupted surface for placing food and other objects on said platform insert.

7. The tray and platform insert of claim 6 in which said cup receiver comprises an upwardly projecting ring having opposing slots therein for receiving a cell phone instead of a cup.

8. The tray and platform insert of claim 7 in which said slots are inclined slightly away from the driver at least on one side, such that a cell phone placed in said slots faces upwardly toward a driver.

9. The tray and platform insert of claim 5 in which said cup receiver comprises an upwardly projecting ring having opposing slots therein for receiving a cell phone instead of a cup.

10. The tray and platform insert of claim 9 in which said slots are inclined slightly away from the driver at least on one side, such that a cell phone placed in said slots faces upwardly toward a driver.
